(19) United States
(12) Patent Application Publication
(10) Pub. No.: US 2022/0052347 A1
(43) Pub. Date: Feb. 17, 2022

(54) POROUS COMPOSITE ELECTRODE HAVING RATIO GRADIENT OF ACTIVE MATERIAL/CURRENT-COLLECTING MATERIAL BY THREE-DIMENSIONAL NANOSTRUCTURE, METHOD FOR MANUFACTURING ELECTRODE AND SECONDARY BATTERY INCLUDING THE ELECTRODE

(71) Applicant: Korea Advanced Institute of Science and Technology, Daejeon (KR)

(72) Inventors: Seokwoo JEON, Daejeon (KR); Gayea HYUN, Daejeon (KR)

(73) Assignee: Korea Advanced Institute of Science and Technology, Daejeon (KR)

(21) Appl. No.: 17/177,507

(22) Filed: Feb. 17, 2021

(30) Foreign Application Priority Data
Aug. 13, 2020 (KR) 10-2020-0101854

(51) Int. Cl. H01M 4/66; H01M 4/78; H01M 10/0525; H01M 4/38; H01M 4/80; H01M 4/04

(52) U.S. Cl. CPC H01M 4/663; H01M 4/78; H01M 10/0525; H01M 4/0404; H01M 4/386; H01M 4/80; H01M 4/661

(57) ABSTRACT

A three-dimensional porous composite electrode includes a three-dimensional porous current-collector and an active material layer including an active material and having a three-dimensional structure along a surface of the three-dimensional porous current-collector. The three-dimensional porous current-collector extends along a first direction, includes a current-collecting material and has a porosity gradient along a second direction perpendicular to the first direction. The three-dimensional porous composite electrode has a ratio gradient of the active material to the current-collecting material along the second direction.

### CROSS-REFERENCE TO RELATED APPLICATION

This application claims priority to and benefits of Korean Patent Application No. 10-2020-0101854 under 35 U.S.C. § 119 filed on Aug. 13, 2020 in the Korean Intellectual Property Office, the entire contents of which are incorporated herein by reference.

### BACKGROUND

### 1. Technical Field

The invention relates to an electrode for a battery. More particularly, the invention relates to an electrode having a ratio gradient of an active material to a current-collecting material by three-dimensional nanostructure, a method for manufacturing an electrode and a secondary battery including the electrode.

### 2. Description of the Related Art

A lithium ion battery, which is being widely used for various portable electronic devices and electric vehicles, requires a high energy density, a high power density and a long cycle durability. However, since a power density of a lithium ion battery is in inverse proportion to an energy density, when a charging rate is increased, a discharging capacity may be reduced by increased energy loss.

Energy loss of a battery may be caused by various polarization such as ohmic polarization, concentration polarization and electrochemical polarization within an electrode, resulting in deterioration of battery performance by inhibiting utilization of active materials.

When lithium ions charged from a cathode are stored in an anode, lithium ions move from an interface of an electrolyte to an interface of a current collector. Thus, polarization of ion concentration may be caused by exhaustion of lithium ions. Battery cell potential of an electrode is determined by a surface composition of an electrode. Thus, a lithium ion concentration on a surface of an anode may be increased by polarization of ion concentration with compared to a lithium ion concentration of a bulk electrode, and premature discharging of a battery may be caused.

In order to solve the above problems, some researchers have suggested cases implementing concentration gradient of an electrode by stacking a plurality of layers including a material advantageous for lithium ion diffusivity and a material advantageous for electron diffusivity with different ratios.

### SUMMARY

One object of the invention is to provide a composite electrode having a ratio gradient of an active material to a current-collecting material by three-dimensional nanostructure.

Another object of the invention is to provide a method of manufacturing the composite electrode.

Another object of the invention is to provide a secondary battery including the composite electrode.

According to an example embodiment of the invention, a three-dimensional porous composite electrode includes a three-dimensional porous current-collector and an active material layer including an active material and having a three-dimensional structure along a surface of the three-dimensional porous current-collector. The three-dimensional porous current-collector extends along a first direction, includes a current-collecting material and has a porosity gradient along a second direction perpendicular to the first direction. The three-dimensional porous composite electrode has a ratio density of the active material to the current-collecting material along the second direction.

In an embodiment, the current-collecting material includes at least one of a metal, a conductive carbon material and a conductive metal oxide.

In an embodiment, the active material includes at least one of a silicon-based active material, a carbon-based active material and a metal oxide active material.

In an embodiment, the three-dimensional porous current-collector has a smaller porosity in a first area adjacent to a first surface thereof than in a second area adjacent to a second surface opposite to the first surface.

In an embodiment, a ratio of the active material to the current-collecting material is larger in the second area than in the first area.

According to an example embodiment of the invention, a method for manufacturing a three-dimensional porous composite electrode is provided. According to the method, a three-dimensional porous current-collector extending along a first direction and including a current-collecting material is formed. A porosity gradient along a second direction perpendicular to the first direction is formed in the three-dimensional porous current-collector. An active material layer, which includes an active material, is formed along a surface of the three-dimensional porous current-collector so that a ratio density of the active material to the current-collecting material is formed along the second direction.

In an embodiment, a three-dimensional porous template is formed on a conductive substrate. A conductive material is filled in the three-dimensional porous template. The three-dimensional porous template is removed to form the three-dimensional porous current-collector with an inverse structure of the three-dimensional porous template. The conductive substrate is removed before the active material layer is formed.

In an embodiment, the active material layer is formed by hydrothermal synthesis.

In an embodiment, the porosity gradient of the three-dimensional porous current-collector is formed by an electro-polishing method.

According to an example embodiment of the invention, a lithium secondary battery includes an anode including the three-dimensional porous composite electrode, a cathode spaced apart from the anode, a separator separating the cathode from the anode, and an electrolyte transferring ions to the cathode or the anode when the lithium secondary battery is charged or discharged.

According to example embodiments of the invention, an electrode has a density gradient (ratio gradient) of the active material to the current-collecting material. Thus, premature discharge of a lithium ion battery due to concentration polarization of lithium ions may be prevented. Furthermore, a rate capability of a lithium ion battery may be improved.

### BRIEF DESCRIPTION OF THE DRAWINGS

FIGS. 1, 2, 3, 4, 5, 6 and 7 are cross-sectional views illustrating a method for manufacturing a composite electrode according to an example embodiment of the present invention.

FIG. 8 is a schematic view illustrating a cross-section and a density gradient of a composite electrode according to an example embodiment of the present invention.

FIG. 9 is an enlarged perspective view illustrating an active material layer of a composite electrode according to an example embodiment of the present invention.

FIG. 10A shows scanning electron microscopy (SEM) pictures of the three-dimensional porous copper nano-structure having uniform pores (3D Cu-UP) and the three-dimensional porous copper nano-structure having a porosity gradient (3D Cu-PG), which were obtained in Example 1, and monochrome pictures converted therefrom.

FIG. 10B is a graph illustrating a pore size of the three-dimensional porous copper nano-structure having uniform pores (3D Cu-UP) and the three-dimensional porous copper nano-structure having a porosity gradient (3D Cu-PG), which were obtained in Example 1.

FIG. 11 shows SEM and energy-dispersive X-ray spectroscopy (EDS) mapping images of the density gradient composite electrode obtained in Example 1.

FIG. 12 is a graph illustrating rate capabilities of composite electrodes of Example 1 (TiO2/3D Cu-PG) and Comparative Examples 1 (TiO2/3D Cu-PG) and 2(TiO2/Cu foil).

### DETAILED DESCRIPTION OF THE EMBODIMENTS

Various embodiments will be described more fully hereinafter with reference to the accompanying drawings, in which some embodiments are shown. The invention may, however, be embodied in many different forms and should not be construed as limited to the embodiments set forth herein. Rather, these embodiments are provided so that this description will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include a plurality of forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

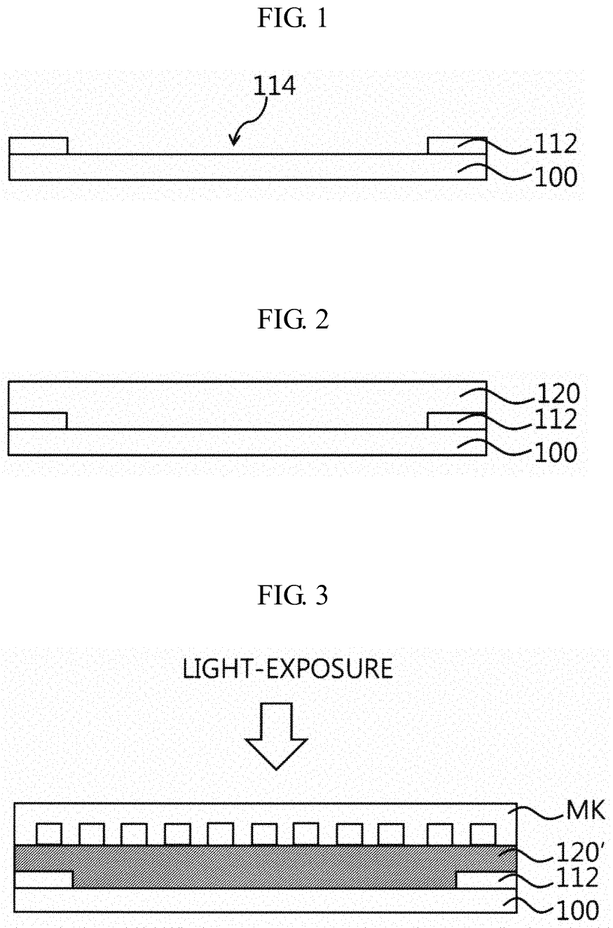

FIGS. 1, 2, 3, 4, 5, 6 and 7 are cross-sectional views illustrating a method for manufacturing a composite electrode according to an example embodiment of the present invention.

Referring to FIG. 1, an adhesive layer 112 is formed on a substrate 100. For example, the adhesive layer 112 may include an opening 114.

In an embodiment, at least a portion of the substrate 100 may include a conductive material. For example, the substrate 100 may entirely include a conductive material, or may include a conductive layer coated on a non-conductive base layer. For example, a conductive layer of the substrate 100 may include Au, Ag, Cu, Al, Co, Ni, Ti, Cr, indium tin oxide, indium zinc oxide or a combination thereof. The conductive layer of the substrate 100 may have a single-layered structure or a multi-layered structure. In an embodiment, the conductive layer of the substrate 100 may have a multi-layered structure including a Ti layer and an Au layer.

The adhesive layer 112 may be formed from a photoresist composition. For example, a first photoresist material may be coated on the substrate 100 through a spin coating process. The first photoresist material coated on the substrate 100 may be preliminarily heated (soft-baked), for example, at about 90° C. to about 100° C. Thereafter, the coated layer may be light-exposed with a portion, which corresponds to the opening 114, being masked, and then developed to remove the masked portion thereby forming the opening 114. For example, the coated layer may be light-exposed by UV ray or the like. Thereafter, the coated layer may be hard-baked on a hot plate at about 100° C. to about 250° C. thereby forming the adhesive layer 112.

Referring to FIG. 2, a photoresist film 120 is formed on the adhesive layer 112. The photoresist film 120 may fill the opening to contact the substrate 100.

In an example embodiment, a second photoresist material may be coated on the adhesive layer 112 and an exposed upper surface of the substrate 100 through a spin coating process. The second photoresist material coated on the substrate 100 may be soft-baked, for example, at about 90° C. to about 100° C. to form the photoresist film 120.

The first photoresist material and the second photoresist material for forming the adhesive layer 112 and the photoresist film 120 may include a same composition or different compositions from each other. In an example embodiment, the first photoresist material or the second photoresist material may include an epoxy-based negative-tone photoresist composition, or a DNQ-based positive-tone photoresist composition. In some example embodiments, the first photoresist material or the second photoresist material may include an organic-inorganic hybrid material, hydrogel, a phenolic resin or the like, which can be cross-linked by light exposure.

In an example embodiment, the adhesive layer 112 may have a thickness of about 0.5 μm to about 5 μm. The photoresist film 120 may have a thickness of about 0.3 μm to about 1 mm, and may preferably have a thickness of about 1 μm to about 100 μm.

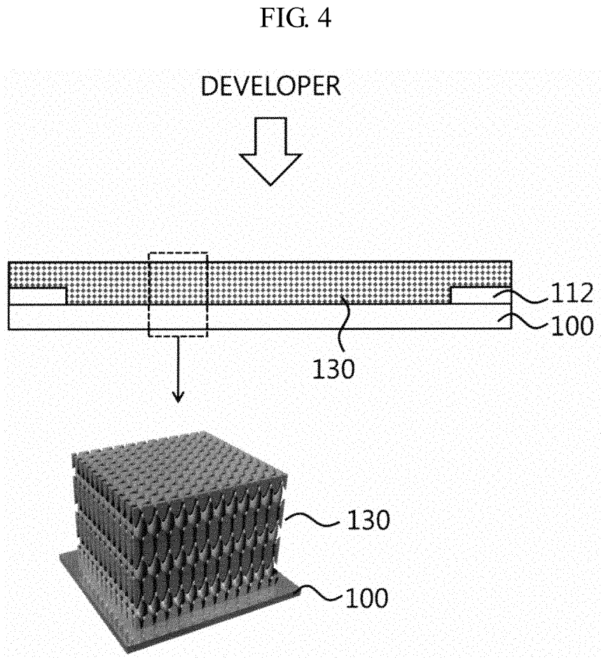

Referring to FIGS. 3 and 4, the photoresist film 120 is exposed to a light. In an example embodiment, a three-dimensionally distributed light is provided to the photoresist film 120′.

The three-dimensional light-exposure may be performed by proximity-field nano-patterning (PnP) method.

In PnP method, a light is irradiated onto a phase mask MK including an elastomer material and a periodic uneven pattern. A light passing through the phase mask MK is periodically three-dimensionally distributed by interference effect. Thus, the photoresist layer may be three-dimensionally exposed to a light. For example, the phase mask MK may have a convexo-concave lattice structure formed at a surface, through which a light passes, and may include a flexible elastomer material. When the phase mask MK contacts the photoresist layer, the phase mask MK may spontaneously adhere to or conformal-contact a surface of the photoresist film by Van der Waals force.

For example, when a laser having a wavelength similar to a periodicity of the lattice-of the phase mask MK is irradiated onto the phase mask MK, a three-dimensionally distributed light may be formed by Talbot effect. When the photoresist film is formed from a negative-tone photoresist composition, cross-linking of a resin may be selectively caused in a portion where light intensity is relatively high by constructive interference, and may be hardly caused in a remaining portion where light intensity is relative low. Thus, the remaining portion, which is barely or not light-exposed, may be removed in a developing process. As a result, a porous polymeric structure having a three-dimensional porous network with a periodicity of hundreds of nanometers to several micrometers. After the developing process, the photoresist film may be dried.

In an example embodiment, a pore size and a periodicity of the porous polymeric structure may be adjusted depending on a wavelength of the laser and a design of the phase mask MK.

More detailed explanation of the PnP method are disclosed in J. Phys. Chem. B 2007, 111, 12945-12958; Proc. Natl. Acad. Sci. U.S.A. 2004, 101, 12428; Adv. Mater. 2004, 16, 1369; and Korean Patent Publication 2006-0109477, which are incorporated herein for references.

In an example embodiment, the phase mask MK used in the PnP process may include a material such as PDMS (polydimetyl siloxane), PUA (polyurethane acrylate), PFPE (perfluoropolyether) or the like.

As explained in the above, when the photoresist film 120 is formed from a negative-tone photoresist composition, a light-exposed portion of the photoresist film 120 may remain while a non-light-exposed portion thereof may be removed. Thus, the three-dimensional porous template 130 including three-dimensional nano-pores may be formed on the substrate 100. Examples of a developing solution may include, for example, PGME (propylene glycol monomethyl ether acetate).

For example, the three-dimensional porous template 130 may include channels formed by nano-scaled pores in a range of about 1 nm to about 2,000 nm, which are three-dimensionally connected to each other entirely or partially. Thus, the three-dimensional porous template 130 may have a three-dimensional network structure periodically distributed by the channels.

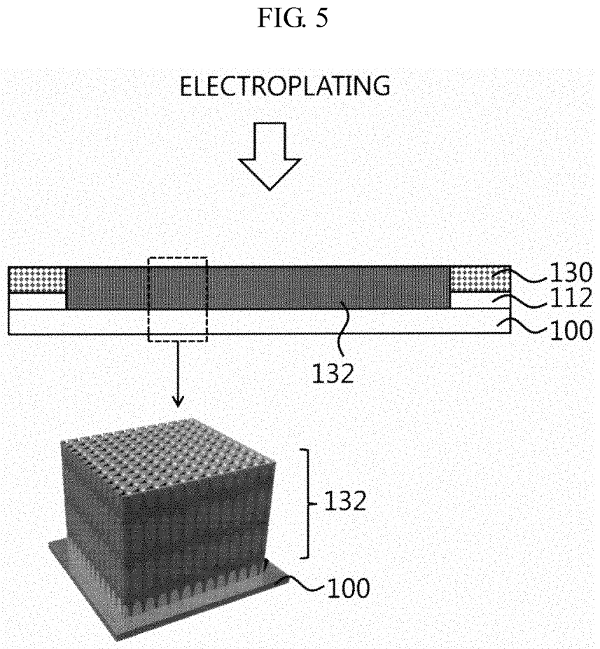

Referring to FIGS. 4 and 5, a conductive material is filled in the pores (channels) of the three-dimensional porous template 130 to form a composite 132 of the three-dimensional porous template 130 and a conductive filler.

For example, the conductive material may be provided by a plating method such as an electroplating method, an electro-less plating method or the like. In an example embodiment, the conductive material may be provided by an electroplating method. However, example embodiments of the present invention are not limited thereto. For example, the conductive material may be provided by various methods including a liquid process, a deposition method or the like, which are known to be capable of filling pores.

In order to perform an electroplating method, an electrolytic cell including a counter electrode, an electrolyte and a working electrode may be used. The substrate 100 with the three-dimensional porous template 130 may be used as a working electrode. The electrolyte may include cations of a conductive material such as a metal. Metal cations in the electrolyte may be moved into the three-dimensional porous template 130 when predetermined voltages are applied to the counter electrode and the working electrode.

For example, the electrolyte may include H₂PtCl₆, CuSO₄, CuCl₂, NiCl₂, CoCl₂, CoCl₃, KAu(CN)₂, KAg(CN)₂ or a combination thereof.

In an example embodiment, the substrate 100 may be used as a cathode in an electroplating process. Thus, the conductive material may be filled selectively in the three-dimensional porous template 130, of which a portion does not overlap the adhesive layer 112.

In an example embodiment, a surface of the three-dimensional porous template 130 may be plasma-treated before the electroplating process. Thus, the surface of the three-dimensional porous template 130 may be changed to be hydrophilic so that the metal cations may easily enter into the three-dimensional porous template 130.

A filling ratio of the conductive material in the three-dimensional porous template 130 may be determined by a voltage, a current, a process time or the like in the electroplating process.

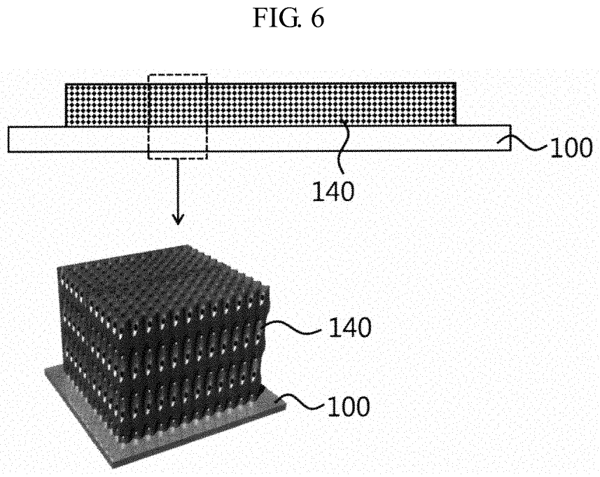

Referring to FIG. 6, the three-dimensional porous template is removed to form a three-dimensional porous current-collector 140. In an example embodiment, the three-dimensional porous current-collector 140 may include copper. However, example embodiments of the present invention are not limited thereto. For example, the three-dimensional porous current-collector 140 may include a transition metal, a novel metal or a combination thereof. Furthermore, the three-dimensional porous current-collector 140 may be formed according to applications thereof by suitable methods using suitable materials. For example, the three-dimensional porous current-collector 140 may be formed of a conductive metal oxide or a conductive carbon material such as graphene, carbon nano-tube or the like by a liquid process, a deposition process or the like instead of an electroplating process.

In an example embodiment, the three-dimensional porous template may be removed by heat treatment, wet-etching, plasma treatment or the like.

The heat treatment may be performed at about 400° C. to about 1,000° C., for example, at an atmosphere including air or oxygen gas. Furthermore, inert gas such as argon (Ar) may be added to the atmosphere.

The plasma treatment may include oxygen-plasma treatment or reactive ion etching (ME).

The three-dimensional porous current-collector 140 may have an inverse structure of the three-dimensional porous template. Thus, the three-dimensional porous current-collector 140 may have a porous structure including pores (channels), which are three-dimensionally connected to each other.

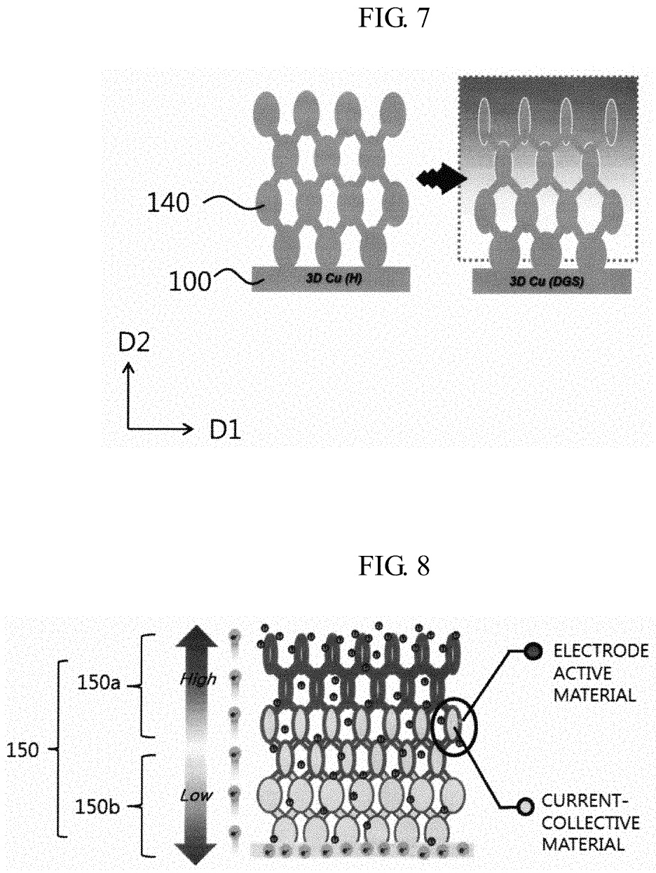

Referring to FIG. 7, the three-dimensional porous current-collector 140 is treated to have a porosity gradient.

For example, the three-dimensional porous current-collector 140 may have an interface with the substrate 100, and the interface may extend along a first direction D1. A porosity of the three-dimensional porous current-collector 140 may vary along a second direction D2, which may be referred to as Z axis direction, perpendicular to the first direction D1.

In an example embodiment, a porosity in a first area of the three-dimensional porous current-collector 140, which is adjacent to the substrate 100, may be smaller than a porosity in a second area of the three-dimensional porous current-collector 140, which is spaced apart from the substrate 100.

In an example embodiment, electro-polishing may be performed to form a porosity gradient in the three-dimensional porous current-collector 140. However, example embodiments of the present invention are not limited thereto, and various methods may be used depending on a desired material and a desired structure.

An electro-polishing process may be performed by inverse of an electroplating process. For example, when a high current density is inversely applied to an electrolyte cell using the three-dimensional porous current-collector 140 as a working electrode, an electrolyte gradient may be formed. Thus, an etching rate may vary in the three-dimensional porous current-collector 140 thereby forming a porosity gradient in the three-dimensional porous current-collector 140. For example, an etching rate in an area adjacent to an electrolyte may be larger than an etching rate in an area adjacent to the substrate 100. Thus, a porosity gradient along the Z axis may be formed.

When a porosity to a thickness is relatively large, it may be difficult to form an electrolyte gradient in a porous nano-structure. Thus, conditions for the electro-polishing process may be experimentally adjusted. The porosity gradient formed by the electro-polishing process may be linear or non-linear, and directions thereof are not specifically limited so that a size and a gradient of the pores may be variously designed in view of applications of an electrode.

In an example embodiment, the substrate 100 may be removed after the electro-polishing process. For example, the substrate 100 may include a conductive layer having a multi-layered structure including a Ti layer and an Au layer, and the Ti layer may contact the three-dimensional porous current-collector 140. Thus, when the substrate 100 with the three-dimensional porous current-collector 140 formed thereon is dipped in an etching solution including hydrofluoric acid or the like, the Ti layer may be dissolved so that the substrate 100 may be separated from the three-dimensional porous current-collector 140. However, example embodiments of the present invention are not limited thereto. For example, the etching solution and a material of a conductive sacrifice layer may be suitably selected to prevent damage to the three-dimensional porous current-collector 140, and an order of processes may be suitably adjusted.

Thereafter, an active material is provided to the three-dimensional porous current-collector 140 to form an active material layer on a surface of the three-dimensional porous current-collector 140. As a result, an electrode 150 having a density gradient of a conductive material, which functions as a current-collector, and an active material, may be formed. The conductive material of the three-dimensional porous current-collector 140 may be referred to as a current-collecting material. The active material may be referred to as an electrode active material.

The active material may include a material having a relatively high lithium ion diffusivity. The active material may include various materials known in the art. For example, the active material may include a metal oxide, a silicon-based active material, a carbon-based active material or a combination thereof. For example, the metal oxide may include titanium oxide, zinc oxide, tin oxide, barium oxide, indium oxide or a combination thereof. For example, the silicon-based active material may include silicon, silicon oxide (SiOx), silicon carbide (SiC), silicon alloy or a combination thereof. For example, the carbon-based active material may include graphite, graphene, carbon nano-tube or a combination thereof.

The active material may be provided by various methods. Any coating method, which may form thin layer not to block channels and may maintain physical and electrochemical characteristic of components such as electron diffusivity of the current collector, may be used for forming the active material layer.

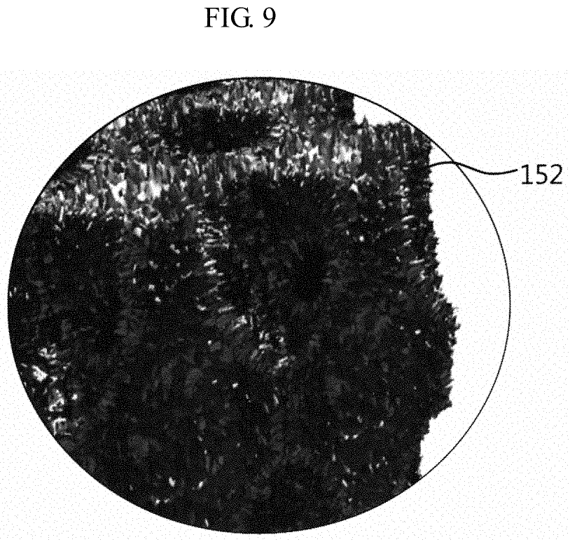

In an example embodiment, the active material layer may include a metal oxide, and may be formed through hydrothermal synthesis reaction. The active material layer formed through hydrothermal synthesis reaction may be relatively high-crystalline to increase reliability and electrical properties. In an example embodiment, as illustrated in FIG. 9, the active material layer 152 may have crystals having a nano-plate shape and may include titanium dioxide (B-phase).

In an example embodiment, the electrode 150 may have a ratio gradient of an active material and a current-collecting material by a porosity gradient of the three-dimensional porous current-collector. The electrode 150 may be individually used, or may be used with a conductive substrate combined therewith.

Referring to FIG. 8, when the electrode 150 is used as an anode of a lithium secondary battery, a ratio of the active material to the current-collecting material may be larger in a first area 150a, which is adjacent to a first surface contacting an electrolyte, than in a second area 150b, which is adjacent to a second surface opposite to the first surface. In an example embodiment, a thickness of the active material layer may be larger in the first area 150a than in the second area 150b, depending on synthesis conditions. However, embodiments are not limited thereto, and a thickness of the active material layer may be uniform in the electrode 50. For example, the ratio of the active material to the current-collecting material may be a volume ratio or a weight ratio. Furthermore, the number of areas forming the density gradient is not specifically limited. The electrode 150 may be divided into N areas so that the ratio of the active material to the current-collecting material may gradually vary from a lower surface to an upper surface.

The above configuration may form a density gradient of the active material to the current-collecting material. Thus, premature discharging of a lithium ion battery due to concentration polarization of lithium ions may be prevented. Furthermore, a rate capability of a lithium ion battery may be improved.

In an example embodiment, a three-dimensional porous current-collector having a porosity gradient may be obtained by etching gradient using electro-polishing of a three-dimensional porous template formed by a PnP method. However, example embodiments of the present invention are not limited thereto. For example, a three-dimensional porous template having a porosity gradient may be formed on a substrate, and then a three-dimensional porous current-collector having an inverse structure of the three-dimensional porous template may be formed.

In an example embodiment, the three-dimensional porous template having a porosity gradient may be formed by a particle self-assembly method. For example, the three-dimensional porous template may have a multi-layered structure in which each layer may include two-dimensionally arranged particles. The particles in different layers may have different sizes so that he three-dimensional porous template may entirely have a porosity gradient. For example, the particles in a layer adjacent to the substrate may have a smaller size.

The particle self-assembly method may be performed through conventionally known processes. For example, a solution including a photo-initiator and inorganic nano-particles stabilized by a stabilizer may be coated on a substrate. A UV ray may be irradiated onto a coated layer to activate the photo-initiator and to cause reaction of ligands on surfaces of the inorganic nano-particles thereby forming a single layer.

The above processes may be repeated to form a multi-layered structure. A size of the inorganic nano-particles may be adjusted to control a particle size in each layers.

The three-dimensional porous template may have pores (channels) defined by a space surrounded by the inorganic nano-particles.

The pores of the three-dimensional porous template may be filled with a conductive material through an electroplating process or the like. Thereafter, the three-dimensional porous template may be removed to form a three-dimensional porous current-collector having a porosity gradient.

A three-dimensional nano-structure electrode may be used for an electrode of a lithium secondary battery.

For example, the lithium secondary battery may include an anode, a separator, a cathode, an electrolyte and a receiving container receiving the anode, the separator, the cathode and the electrolyte. The above-explained three-dimensional nano-structure electrode may be used for the anode.

The cathode may include a current-collector and an active material layer. The active material layer of the cathode may include an oxide of lithium and a transition metal.

For example, the oxide of lithium and a transition metal may include lithium cobalt oxide, lithium nickel oxide, lithium manganese oxide or a combination thereof.

The separator may prevent electrical contact of the anode and the cathode. For example, the separator may include a porous polymer film or a stacked structure thereof. The porous polymer film may include a polyolefin polymer such as polyethylene, polypropylene, ethylene/butene copolymer, ethylene/hexene copolymer, ethylene/methacrylate copolymer or the like. However, example embodiments of the present invention are not limited thereto. For example, the separator may include a glass fiber with a high melting point, a non-woven fabric including polyethylene terephthalate or the like.

The electrolyte may transfer ions to the anode or the cathode when the battery is charged or discharged. The electrolyte may include propylene carbonate (PC), ethylene carbonate (EC), diethyl carbonate (DEC), dimethyl carbonate (DMC), dipropyl carbonate (DPC), dimethyl sulfoxide, acetonitrile, dimethoxy ethane, diethoxy ethane, tetrahydrofuran, N-methyl-2-pyrollidone (NMP), ethylmethyl carbonate (EMC), gamma-butyrolactone (GBL), fluoroethylene carbonate (FEC), methyl formate, ethyl formate, propyl formate, methyl acetate, ethyl acetate, propyl acetate, pentyl acetate, methyl propionate, ethyl propionate, propyl propionate, butyl propionate or a combination thereof. Furthermore, the electrolyte may further include a lithium salt.

Hereinafter, effects and manufacturing methods of electrodes according to example embodiments will be explained with reference to following examples.

### EXAMPLE 1: MANUFACTURING ELECTRODE WITH DENSITY GRADIENT BY POROSITY GRADIENT OF THREE-DIMENSIONAL NANO-STRUCTURE

### 1. Manufacturing Three-Dimensional Porous Template Based on a Polymer by Using PnP Method

A photoresist composition (trade name: SU-8 2, manufactured by Micro Chem) was spin-coated on an SiO2/Si substrate with a Ti layer (100 nm) and an Au layer (50 nm), which were deposited thereon, for 30 seconds by 3,000 rpm, and heated on a hot plate at 65° C. for 2 minutes and at 95° C. for 3 minutes to form a coated layer. Thereafter, a chrome mask was disposed on the coated layer, and the coated layer was exposed to a UV lamp of 365 nm for 1 minute and heated at 120° C. for 3 minutes to cross-link the photoresist composition unmasked by the chrome mask. Thereafter, a developer was provided to the coated layer to remove a portion, which was not light-exposed, thereby forming an adhesive layer having an opening. A photoresist composition (SU-8 50) was spin-coated for 40 seconds by 4,000 rpm, and heated on a hot plate at 65° C. and at 95° C. to form a photoresist film.

A phase mask formed of PDMS and having a convexo-concave surface with a periodically arranged rectangular lattice was disposed to contact the photoresist film. The phase mask included nano-pillars with a height of 420 nm, which were arranged in a square array with a periodicity (pitch) of 600 nm. An Nd:YAG laser having a wavelength of 365 nm was irradiated to the photoresist film through the phase mask with 16 mJ, and a developer was provided to form a three-dimensional porous template having pores (channels) network periodically arranged along X axis, Y axis and Z axis.

### 2. Forming Porous Nano-Structure Through Electroplating Process

The three-dimensional porous template was filled with copper through an electroplating process. An electroplating bath included an electrolyte including 0.15M of copper sulfate and 0.5 M of sulfuric acid. A copper plate was used as a counter electrode. A pulse-electroplating process was performed to periodically provide a current of −10 mA/cm² to entirely fill the pores of the three-dimensional porous template, which had a size of 200-300 nm, until a thickness of 15 μm. Thereafter, the three-dimensional porous template was removed by a plasma-etching apparatus using O₂, N₂ and CF₄ to form a three-dimensional porous copper nano-structure having an inverse structure of the three-dimensional porous template.

### 3. Forming Porosity Gradient of Nano-Structure Through Electro-Polishing Process

A current of +10˜+50 mA/cm² was provided to the three-dimensional porous copper nano-structure under same conditions as “2.” to electro-polish the three-dimensional porous copper nano-structure. As a result, a porosity gradient along Z axis was formed in the three-dimensional porous copper nano-structure. Thereafter, the three-dimensional porous copper nano-structure with the substrate was dipped in a 10% hydrofluoric acid solution to dissolve the Ti layer. As a result, the three-dimensional porous copper nano-structure from the substrate was separated from the substrate, and a free-standing film of the three-dimensional porous copper nano-structure was obtained.

### 4. Coating TiO₂ on Three-Dimensional Nano-Structure Having Porosity Gradient Through Hydrothermal Synthesis

The three-dimensional porous copper nano-structure was put in a Teflon chamber filled with ethylene glycol (98%), distilled water and TiCl₃ to prepare a hydrothermal synthesis reactor. The hydrothermal synthesis reactor was dipped in a silicone oil bath of 150° C. and heated for 9-22 hours for hydrothermal synthesis. Thereafter, the three-dimensional porous copper nano-structure was washed, dried and heated at 350° C. in an atmosphere of Ar and H₂ to form a TiO₂ active material layer having a nano-plate shaped crystals, which was coated on a surface of the three-dimensional porous copper nano-structure. The TiO₂ active material layer and the three-dimensional porous copper nano-structure formed a density gradient of materials along Z axis.

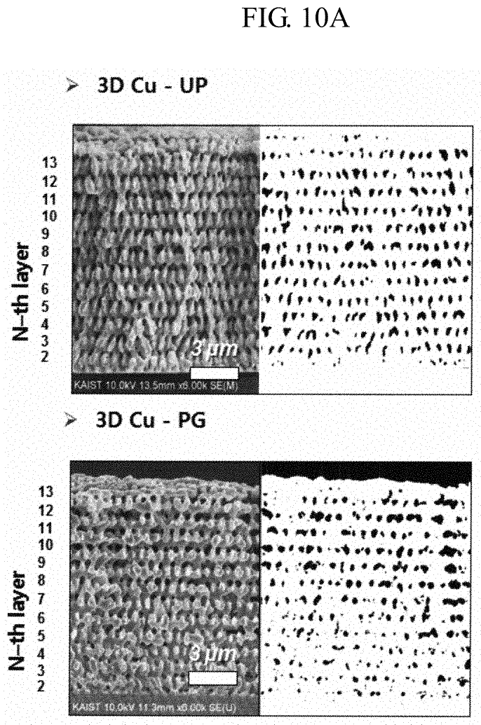

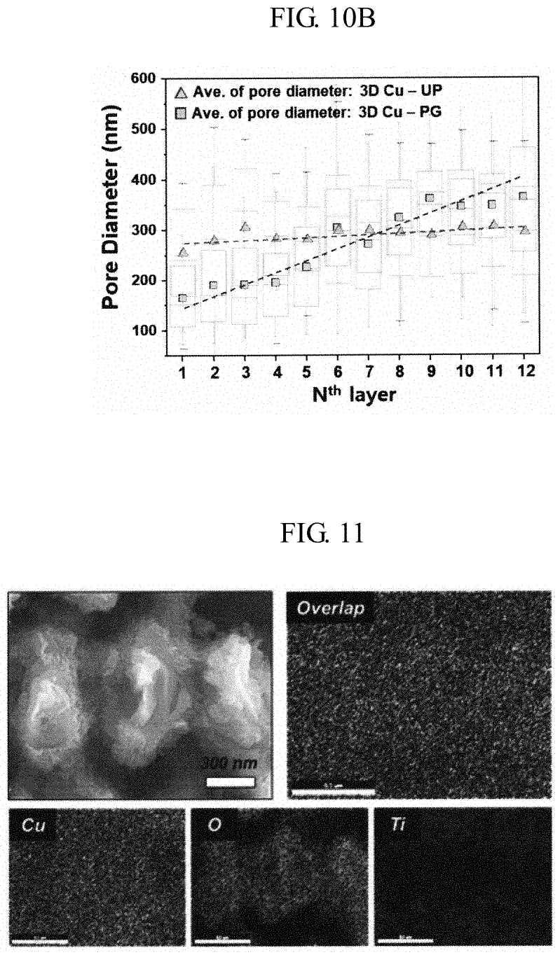

FIG. 10A shows scanning electron microscopy (SEM) pictures of the three-dimensional porous copper nano-structure having uniform pores (3D Cu-UP) and the three-dimensional porous copper nano-structure having a porosity gradient (3D Cu-PG), which were obtained in Example 1, and monochrome pictures converted therefrom.

FIG. 10B is a graph illustrating a pore size of the three-dimensional porous copper nano-structure having uniform pores (3D Cu-UP) and the three-dimensional porous copper nano-structure having a porosity gradient (3D Cu-PG), which were obtained in Example 1.

Referring to FIGS. 10A and 10B, it can be noted that a porosity gradient along Z axis was formed in three-dimensional porous copper nano-structure through an electro-polishing process.

FIG. 11 shows SEM and energy-dispersive X-ray spectroscopy (EDS) mapping images of the density gradient composite electrode obtained in Example 1.

Referring to FIG. 11, it can be noted that TiO₂ was uniformly coated on a surface of the three-dimensional porous copper nano-structure thorough hydrothermal synthesis and heat treatment.

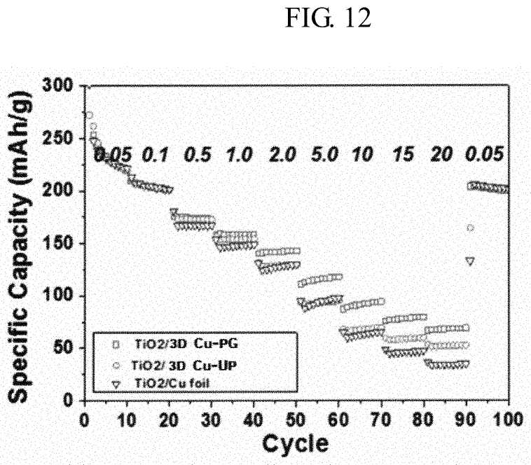

FIG. 12 is a graph illustrating rate capabilities of composite electrodes of Example 1 (TiO2/3D Cu-PG) and Comparative Examples 1 (TiO2/3D Cu-PG) and 2(TiO2/Cu foil).

As Comparative Example 1, a TiO₂ active material layer was coated on a surface of a three-dimensional porous copper nano-structure having uniform pores through hydrothermal synthesis to prepare a composite electrode. As Comparative Example 2, a TiO₂ active material layer was coated on a surface of a copper foil through hydrothermal synthesis to prepare an electrode. Lithium ion coin cells including the composite electrodes of Example 1, Comparative Examples 1 and 2 as a cathode were prepared. Rate capabilities of the lithium ion coin cells were measured by 10 cycles with a charging/discharging current density in a range of 0.05 A g⁻¹ to 20 A g⁻¹, and represented by FIG. 12.

Referring to FIG. 12, it can be noted that the lithium ion coin cell including the density gradient composite electrode of Example 1 had the largest rate capability. Particularly, a discharging capacitance of the lithium ion coin cell was about 70 mAh g⁻¹ at 20 A g⁻¹.

Three-dimensional nano-structure electrode according to example embodiments may be used for an electrode of various energy-storing devices including a lithium secondary battery.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A three-dimensional porous composite electrode comprising:
a three-dimensional porous current-collector extending along a first direction, including a current-collecting material and having a porosity gradient along a second direction perpendicular to the first direction; and
an active material layer including an active material and having a three-dimensional structure along a surface of the three-dimensional porous current-collector, such that the three-dimensional porous composite electrode has a ratio density of the active material to the current-collecting material along the second direction.

2. The three-dimensional porous composite electrode of claim 1, wherein the current-collecting material includes at least one of a metal, a conductive carbon material and a conductive metal oxide.

3. The three-dimensional porous composite electrode of claim 2, wherein the active material includes at least one of a silicon-based active material, a carbon-based active material and a metal oxide active material.

4. The three-dimensional porous composite electrode of claim 1, wherein the three-dimensional porous current-collector has a smaller porosity in a first area adjacent to a first surface thereof than in a second area adjacent to a second surface opposite to the first surface.

5. The three-dimensional porous composite electrode of claim 4, wherein a ratio of the active material to the current-collecting material is larger in the second area than in the first area.

6. A method of manufacturing a three-dimensional porous composite electrode, the method comprising:
forming a three-dimensional porous current-collector extending along a first direction and including a current-collecting material;
forming a porosity gradient along a second direction perpendicular to the first direction in the three-dimensional porous current-collector; and
forming an active material layer, which includes an active material, along a surface of the three-dimensional porous current-collector so that a ratio density of the active material to the current-collecting material is formed along the second direction.

7. The method of claim 6, wherein forming the three-dimensional porous current-collector comprises:
forming a three-dimensional porous template on a conductive substrate;
filling a conductive material in the three-dimensional porous template;
removing the three-dimensional porous template to form the three-dimensional porous current-collector with an inverse structure of the three-dimensional porous template; and
removing the conductive substrate before forming the active material layer.

8. The method of claim 7, wherein the three-dimensional porous current-collector has a smaller porosity in a first area adjacent to the conductive substrate than in a second area spaced apart from the conductive substrate.

9. The method of claim 8, wherein a ratio of the active material to the current-collecting material is larger in the second area than in the first area.

10. The method of claim 6, wherein the active material layer is formed by hydrothermal synthesis.

11. The method of claim 6, wherein the porosity gradient of the three-dimensional porous current-collector is formed by an electro-polishing method.

12. A lithium secondary battery comprising:
an anode including the three-dimensional porous composite electrode of claim 1;
a cathode spaced apart from the anode;
a separator separating the cathode from the anode; and
an electrolyte transferring ions to the cathode or the anode when the lithium secondary battery is charged or discharged.
